(19) United States
(12) Patent Application Publication
(10) Pub. No.: US 2010/0277743 A1
(43) Pub. Date: Nov. 4, 2010

(54) PHOTOREFRACTIVE INTERFEROMETER

(75) Inventors: Uri Voitsechov, Moshav Amirim (IL); Arkady Khachaturov, Haifa (IL); Avram Matcovitch, Nesher (IL)

Correspondence Address: MARTIN D. MOYNIHAN d/b/a PRTSI, INC., P.O. BOX 16446, ARLINGTON, VA, 22215, US

(73) Assignee: Bioscan Technologies, Ltd., Yokneam IIit (IL)

(21) Appl. No.: 12/438,008

(22) PCT Filed: Aug. 22, 2006
(86) PCT No.: PCT/IB2006/052902

§ 371 Date: Jul. 21, 2010

(51) Int. Cl. G01B 9/02

(52) U.S. Cl. 356/491

(57) ABSTRACT

A method of coupling optical energy comprising: generating a first beam of optical energy; generating a second beam of optical energy coherent with the first beam; polarizing optical energy from the first and second beams in a same direction; and transmitting the polarized optical energy from the first and second beams into a photorefractive body so that the energy interferes in the body to generate an interference pattern that is extant in substantially all the volume of the body.

The present invention relates to the interaction of light with a photorefractive material and in particular photorefractive interferometers.

### BACKGROUND OF THE INVENTION

Photorefractive interferometers are well known and are often used to determine characteristics, such as degree of roughness, and/or motion of a surface, hereinafter referred to as a “test surface” or optical characteristics of a volume, hereinafter a “test volume”, of a material. For example, U.S. Pat. No. 6,115,127, the disclosure of which is incorporated herein by reference, describes using a photorefractive interferometer in an apparatus for non-contact measurement of characteristics of a moving paper web by determining characteristics of the propagation of an ultrasonic wave along the web. The wave is detected by using a photorefractive interferometer to detect displacement of the surface of the web that the wave causes.

Photorefractive interferometers generally comprise a source of coherent light that is used to provide first and second coherent light beams that are polarized in a same direction and directed to interact in a body, hereinafter referred to as a photorefractive body, formed from a photorefractive material, such as for example lithium niobate (LiNbO₃), barium titanate (BaTiO₃), bismuth silicon oxide (Bi₂SiO₂₀), potassium niobate (KNbO₃), gallium arsenide (GaAs) and strontium barium niobate (SBN). Light in the first beam, referred to as a “reference beam”, is generally directed over a fixed path to the photorefractive body. Light in the second beam, often conventionally referred to as a “signal beam”, is directed to the photorefractive body over a second path at some region of which the light is reflected off a test surface or passed through a test volume. The two beams are directed to enter the photorefractive body at a non-zero angle relative to each other and so that their fields overlap in the photorefractive body.

In the photorefractive body the fields of the light beams interact to create an interference pattern that excites charge carriers, generally electrons, into the conduction band from regions of the photorefractive body where the light beams interfere constructively and generate a strong electromagnetic field. The charge carriers drift away from the constructive interference regions leaving behind immobile donor atoms and concentrate in the regions of the photorefractive body where the beams interfere destructively and the electromagnetic field of the interference pattern is relatively weak or zero.

The charged immobile donors concentrated in the high field regions and the mobile carriers concentrated in the low field regions generate a space charge field that modulates the index of refraction of the material. The modulated index of refraction generates a “photorefractive” diffraction grating that couples the beams so that energy from one of the beams is transferred to the other of the beams. Generally, an external potential difference is applied to the photorefractive body to generate an internal “applied” electric field in the photorefractive body that enhances motion of the mobile charge carriers away from the high field regions towards the low field regions. It has been found that the application of the external voltage can substantially increase modulation of the index of refraction of the material by the interference pattern and enhance the photorefractive grating and thereby the coupling of the beams.

Which beam donates energy and which one receives energy and an amount of donated energy, depend on the relative phase of the beams and change with change in the position of the test surface (for example, as a result of motion of the surface and/or its roughness). Intensity of one of the beams after it exits the photorefractive body is sensed by a suitable detector to detect and determine change in the position of the surface.

### SUMMARY OF THE INVENTION

An aspect of some embodiments of the invention relates to providing a photorefractive interferometer having improved sensitivity.

As mentioned above, an external voltage is generally applied to a photorefractive body comprised in a photorefractive interferometer to enhance diffractive coupling of the interferometer's reference and signal beams. The inventors have noted that photorefractive materials by their nature are photoconductive, i.e. the application of optical energy to the material generates mobile charge carriers and thereby increases conductivity of the material. However, the same photoconductivity of the material that enables the material to exhibit photorefractivity operates to reduce effectiveness of the applied voltage in enhancing the material's photorefractive effect in the presence of interfering light waves, in particular when the electromagnetic interference field generated by the light waves is relatively inhomogeneous.

In regions where the light waves in the reference and signal beams generate a strong electromagnetic interference field, the conductivity, i.e. photoconductivity, of the material is increased. In the regions of increased conductivity, the applied electric field generated by the applied voltage is reduced, thereby reducing the effectiveness of the applied field in enhancing motion of mobile charge carriers away from the regions of constructive interference of the beams towards the regions of destructive interference. On the other hand, in regions of the photorefractive body where the light beams generate a relatively weak, or no electromagnetic interference field, the photoconductivity is relatively low and the applied field is relatively strong. The applied electric field is strongest in just those regions where it is not effective, in the unexposed low conductivity regions, and weakest in those regions where it is advantageous, in the regions where the electromagnetic interference field is most intense. As a result, effectiveness of the applied field in enhancing the photorefractive diffraction grating and diffractive coupling of the reference and signal beams in the photorefractive body is reduced.

In particular, conventional configurations of reference and signals beams in a photorefractive body of a photorefractive interferometer result in substantial spatial inhomogeneity in an electromagnetic interference field generated in the photorefractive body volume by the beams. The inhomogeneity results both because the beam envelops do not extend to illuminate substantially all the volume of the photorefractive body and because the intensity profiles of the beams within their respective envelopes are relatively non-uniform.

Accordingly, an aspect of some embodiments of the invention relates to providing a photorefractive interferometer for which a pattern of an electromagnetic interference field generated by reference and signal beams in the interferometer's photorefractive body is more uniform throughout the photorefractive body volume than in conventional interferometers. As a result, a portion of the photorefractive body volume for which conductivity is relatively low in the presence of the interfering beams and which inordinately concentrates an applied electric field at the expense of the electric field in desired regions of the photorefractive body, is reduced and sensitivity of the interferometer is improved.

In an embodiment of the invention, to provide the uniformly distributed interference pattern, three coherent beams are generated from the interferometer's light source and are configured so that their intensities are relatively uniform over their respective cross sections. The sizes of the beam cross sections and the directions along which the beams enter the photorefractive body are determined to generate a symmetric interference pattern that is relatively uniform and distributed throughout the interferometer's photorefractive body. All the beams intersect substantially in a same region and two of the three beams are symmetrically located with respect to the third beam. Optionally, the third beam is a reference beam and the two symmetrically positioned beams are identical signal beams.

An aspect of some embodiments of the invention relates to providing a photorefractive interferometer that compensates for polarization instability in a signal beam of the interferometer.

In many photorefractive interferometers, the signal beam is transmitted to a test surface and back from the test surface to the interferometer photorefractive body via an optic fiber. Transmission over the fiber, and/or reflection from a test surface, often results in disturbance of the polarization state of the signal beam. If the beam enters the fiber with a given known polarization state, it exits the fiber with an unknown disturbance of the state. However, a portion of the optical energy in the signal beam that interferes with the reference beam is that portion that has a same polarization as the reference beam. If the polarization state of the signal beam is not stable, but changes in time, accuracy and reliability of measurements provided by the interferometer may be compromised. For example, assume that it is desired to measure distance or roughness of a test surface using the interferometer. An amount of energy exchanged between the reference and signal beams may reflect the change in polarization state of the signal beam and not a change in distance or roughness of the test surface. To reduce instability in the measurements provided by an interferometer in accordance with an embodiment of the invention, substantially all the optical energy in the signal beam that returns from a test surface is polarized to a same state as that of the reference beam.

In some embodiments of the invention, optical energy in the signal beam is polarized to the reference beam polarization state using a Faraday rotator. Optionally, the optical energy in the signal beam is polarized to the reference beam polarization using a configuration of reflectors and beam splitters such as that shown in PCT Publication WO 2004/077100, the disclosure of which is incorporated herein by reference. A photorefractive interferometer, in accordance with an embodiment of the invention, therefore is conservative of optical energy in the signal beam and is relatively efficient in using the energy to interfere with the reference beam.

There is therefore provided in accordance with an embodiment of the invention, a method of coupling optical energy comprising: generating a first beam of optical energy; generating a second beam of optical energy coherent with the first beam; polarizing optical energy from the first and second beams in a same direction; and transmitting the polarized optical energy from the first and second beams into a photorefractive body so that the energy interferes in the body to generate an interference pattern that is extant in substantially all the volume of the body.

Optionally, transmitting optical energy from the second beam comprises splitting the beam into third and fourth beams and transmitting the third and fourth beams into the body. Optionally, transmitting the first, third and fourth beams comprises transmitting them in directions so that the third and fourth beams intersect at an angle that is substantially bisected by the first beam.

In some embodiments of the invention the method comprises configuring the beams so that intensity of the optical energy transmitted into the photorefractive body from each beam is relatively uniform over the beam's cross section.

In some embodiments of the invention the method comprises configuring the beams to maximize an expression of the form:

$$\frac{1}{( {\int }_{0}^{L} I ( x ) \cdot d x ) \cdot ( {\int }_{0}^{L} \frac{d x}{I ( x )} )}$$

where I(x) is intensity of the electromagnetic interference field and the integral is performed over a coordinate x along a direction perpendicular to the direction of polarization of the beams that lies in a cross section of the photorefractive body substantially parallel to a surface at which the beams enter the body and L is a dimension of the cross section of the body.

Additionally or alternatively generating the beams optionally comprises generating beams having Gaussian intensity profiles characterized by a same radius that characterizes rates at which intensities of the beams decrease with distance from the centers of their respective cross sections. Optionally the method comprises, determining a cross section size of each beam responsive to the radius of the beam and a dimension of the photorefractive body. Additionally or alternatively determining the size of each beam optionally comprises determining the size responsive to a ratio between the radius of the beam and a dimension of the photorefractive body.

In some embodiments of the invention the method comprises applying a potential difference to the photorefractive body to generate an applied electric field in the body.

There is further provided in accordance with an embodiment of the invention, an interferometer comprising: a first beam of optical energy; a second beam of optical energy coherent with the first beam; a photorefractive body; and optics that polarizes optical energy in the beams along a same direction and directs the polarized optical energy from the first and second beams into the photorefractive body so that they interfere in the body to generate an interference pattern that is extant in substantially all the volume of the body.

Optionally, the optics splits the second beam into third and fourth beams. Optionally, the optics that directs optical energy comprises optics that directs the first, third and fourth beams so that the third and fourth beams intersect at an angle that is substantially bisected by the first beam.

Optionally, the interferometer comprises optics that configures the beams to maximize an expression of the form:

$$\frac{1}{( {\int }_{0}^{L} I ( x ) \cdot d x ) \cdot ( {\int }_{0}^{L} \frac{d x}{I ( x )} )}$$

where I(x) is intensity of the electromagnetic interference field generated by the first, third and fourth beams and the integral is performed over a coordinate x along a direction perpendicular to the direction of polarization of the beams that lies in a cross section of the photorefractive body substantially parallel to a surface at which the beams enter the body and L is a dimension of the cross section.

In some embodiments of the invention the interferometer comprises a laser that provides light for both the first and second beams. Optionally, the interferometer comprises a first beam splitter that splits light from the laser into the first and second beams. Optionally, the first beam splitter is a polarizing beam splitter that polarizes the light in the first and second beams in first and second directions respectively that are orthogonal to each other.

Optionally, the optics comprises a Faraday rotator and optics that directs at least some of the light in the second beam to pass at least twice through the Faraday rotator before it enters the photorefractive body. For each pass of the light through the Faraday rotator, the polarization direction of the light is rotated by optionally 45°.

Additionally or alternatively the interferometer optionally comprises a non-polarizing beam splitter that receives light that passes through the Faraday rotator twice and splits the received light into the third and fourth beams. Optionally, the interferometer splits equal portions of the received light into the third and fourth beams.

Additionally or alternatively, the interferometer optionally comprises a second polarizing beam splitter that receives light that has passed through the Faraday rotator only once and transmits light polarized in the second direction and reflects light polarized in the first direction. Optionally, the second polarizing beam splitter reflects light polarized in the second direction to the non-polarizing beam splitter, which splits the received light into the third and fourth beams.

In some embodiments of the invention, the optics that directs the light to pass at least twice through the Faraday rotator comprises a second polarizing beam splitter that receives light from the Faraday rotator that has passed though the rotator only once and has its polarization direction rotated into a third polarization direction at 45° to the second polarization direction. Optionally, the second polarizing beam splitter transmits light polarized in the third direction and reflects light polarized in a fourth polarization direction that is perpendicular to the third polarization direction. The interferometer optionally comprises a mirror that reflects light polarized in the fourth direction that is reflected by the second beam splitter back to the second beam splitter.

In some embodiments of the invention, the interferometer comprises a power supply that applies a potential difference to the photorefractive body to generate an applied electric field in the body.

There is further provided in accordance with an embodiment of the invention, a method of polarizing optical energy in a beam comprising: polarizing optical energy in the beam in a first direction; transmitting the polarized optical energy through a Faraday rotator that rotates the polarization from the first direction to a second direction; directing the light from the Faraday rotator to a polarizing beam splitter that transmits light in the second direction and reflects light polarized orthogonal to the second direction; reflecting light that is transmitted by the beam splitter from a reflective element back to the beam splitter; directing light from the reflective element that passes through the beam splitter to pass through the Faraday rotator; and

directing light from the reflective element that is reflected by the beam splitter, back to the beam splitter without changing the polarization of the light so that the light directed back to the beam splitter is again reflected by the reflective element back to the beam splitter.

### BRIEF DESCRIPTION OF FIGURES

Non-limiting examples of embodiments of the present invention are described below with reference to figures attached hereto. In the figures, identical structures, elements or parts that appear in more than one figure are generally labeled with a same symbol in all the figures in which they appear. Dimensions of components and features shown in the figures are chosen for convenience and clarity of presentation and are not necessarily shown to scale. The figures are listed below.

FIGS. 1A-1C schematically show reference and signal beams interfering in a photorefractive body, in accordance with prior art;

FIG. 2A schematically shows a reference beam and two signal beams interfering in a photorefractive body in accordance with an embodiment of the present invention;

FIG. 2B shows a graph of efficiency of a photorefractive interferometer as a function of intensity profile of its reference and signal beams and size of its photorefractive body, in accordance with an embodiment of the invention;

FIG. 3 schematically shows an interferometer comprising the photorefractive body and optical beams shown in FIG. 2A, in accordance with an embodiment of the invention; and

FIG. 4 schematically shows another interferometer comprising the photorefractive body and optical beams shown in FIG. 2A, in accordance with an embodiment of the invention.

### DETAILED DESCRIPTION OF EXEMPLARY EMBODIMENTS

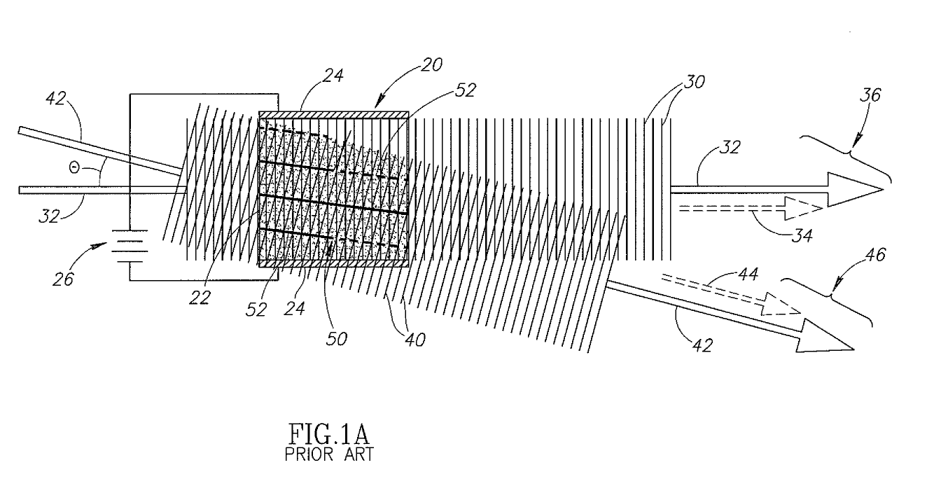

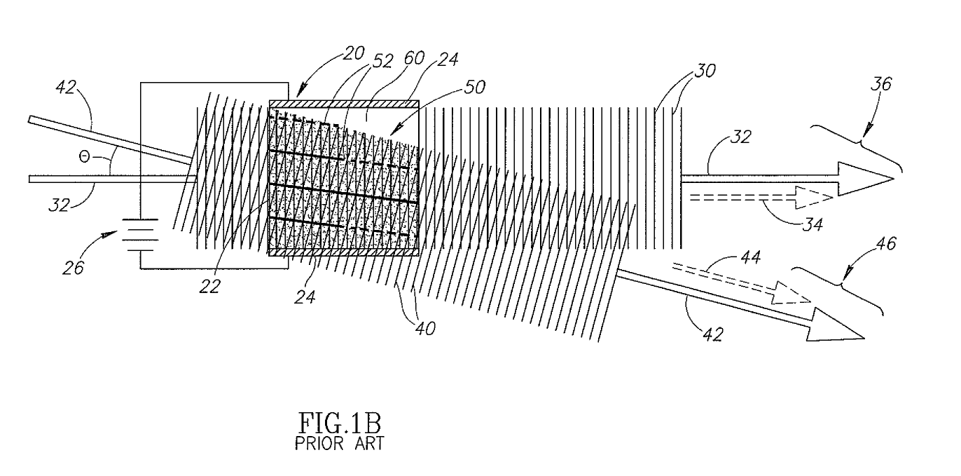

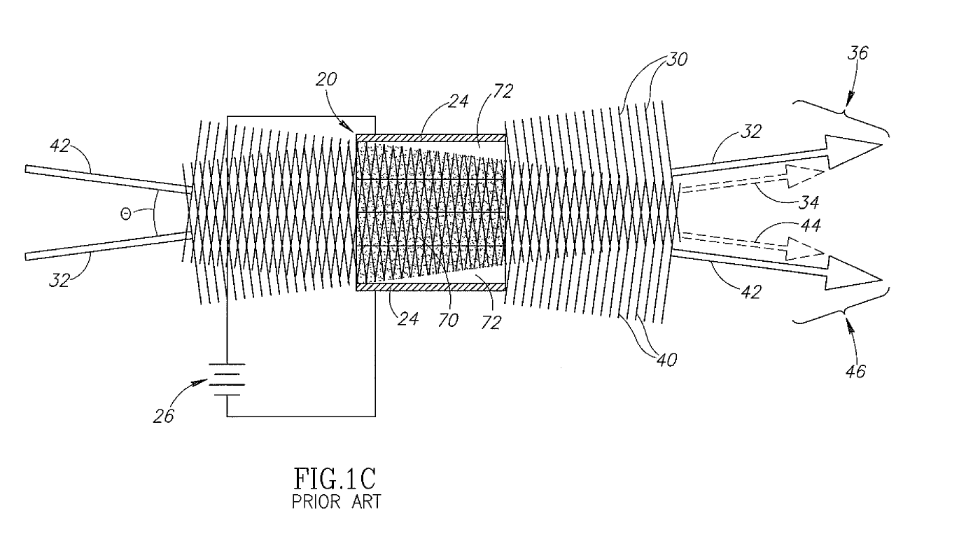

FIG. 1A schematically shows a photorefractive body 20 and a configuration of a reference beam and a signal beam in a photorefractive interferometer in accordance with prior art. The reference and signal beams are assumed for simplicity of presentation to be planar waves and polarized in a direction perpendicular to the plane of FIG. 1.

The reference beam is schematically indicated by a plurality of parallel lines 30 representative of wavefronts in the optical field of the beam having a same phase, e.g. crests, at a particular instant in time and by a block arrow 32 indicative of the direction of the beam. For convenience, the reference beam will be referred to by the numerical label of its block arrow, i.e. as “reference beam 32”. The signal beam is similarly referred to by the numeral 42 that labels a block arrow 42 indicating a propagation direction of the signal beam and is schematically shown at the same particular time at which reference beam 32 is shown. At the particular time, signal beam 42 is characterized by wavefronts 40 having a same phase as wavefronts 30 in the reference beam.

Reference and signal beams 32 and 42 are shown entering photorefractive body 20 at a “face” 22 of the photorefractive body. By way of example, reference beam 32 enters photorefractive body 20 along the normal to face 22 of the photorefractive body and energy in the reference beam exits crystal 20 at a normal to face 22 of the photorefractive body. Signal beam 42 enters photorefractive body 20 at a “mixing” angle θ with respect to the normal to face 22 and with respect to the direction of propagation of reference beam 32. Generally, θ is between about 1° and about 45°. A photorefractive body typically exhibits photorefractive coupling of a reference and signal beam over a relatively large range of mixing angles with photorefractive efficiency, decreasing with increasing difference of the angle from an optimum mixing angle. The range of mixing angles and the optimum mixing angle, are material dependent. Photorefractive efficiency of an interferometer is defined as a relative change in intensity of a monitored signal or reference beam upon exit from the photorefractive body per unit change in phase between the beams at entry into the photorefractive body. Relative change in a reference or signal beam intensity is a change in intensity of the beam relative to a total optical energy provided by a light source that is used to provide the reference and signal beams.

Signal beam 42 will in general be refracted at face 22 and an angle inside photorefractive body 20 between the directions of propagation of reference and signal beams 32 and 42 will be different (in general smaller) from θ. For convenience of presentation, a change in the attitude of wavefronts 40 inside photorefractive body 20 relative to the direction of wavefronts 40 outside the photorefractive body that would schematically represent the refracted change in direction of propagation of the signal beam in photorefractive body 20 is not shown.

Reference and signal beams 32 and 42 interfere in photorefractive body 20 and generate an interference pattern in the electromagnetic field in the photorefractive body in a region 50 of the photorefractive body where the beams overlap. Region 50 is shaded for clarity of presentation. The numeral 50 labeling the overlap region is also used to refer to the interference pattern in the overlap region.

Assume a relatively simple model of the interaction of reference and signal beams 32 and 42 in photorefractive body 20 and that photorefractive body 20 has dimensions that are much larger than the wavelength of light in the reference and signal beams and that edge effects and inhomogeneities in photorefractive body 20 can be ignored. Then, surfaces of equal amplitude in the electromagnetic field interference pattern 50 that is generated in photorefractive body 20 by the reference and signal beams are substantially planar and parallel to each other. Planar surfaces of constructive interference that are characterized by a maximum in the amplitude of the electromagnetic interference field in photorefractive body 20 are indicated by lines 52. Regions of destructive, minimum electromagnetic field in interference pattern 50, lie on planes (not shown) that are parallel to and half way between every pair of adjacent maximum interference planes 52.

As noted above, in regions of constructive interference, mobile charge carriers are generated by the interference field and the charges migrate and settle in and in the vicinity of the destructive interference regions of the interference field and generate thereby a photorefractive space charge distribution in photorefractive body 20. Generally, migration of the mobile charge carriers is enhanced by application of an external potential difference to photorefractive body 20 to generate an applied field in the photorefractive body that increases rate of migration of the carriers to the destructive interference regions.

In FIG. 1A and the figures that follow, photorefractive body 20 is shown sandwiched between electrodes 24. A power supply 26 electrifies electrodes 24 to provide the applied field that enhances the migration of the charged mobile carriers and generation of a photorefractive space charge distribution in the photorefractive body. If photorefractive body 20 is a BSO crystal, typically, voltage is applied to a photorefractive body 20 to generate a DC or low frequency (up to about 2 kHz) AC applied electric field having a magnitude in the photorefractive body in a range from about 1 kV/cm to about 10 kV/cm.

The space charge distribution in the photorefractive body generates an electric space charge field in the photorefractive body. Surfaces of equal space charge density in photorefractive body 20 tend to follow the contours of planes 52 and be parallel to planes 52. For simplicity, the surfaces of equal space charge density are assumed to be planes that are parallel to planes 52. The space charge field is substantially perpendicular to the equal space charge density planes and to planes 52. The space charge field modulates the index of refraction and for locations on a same “index of refraction plane” parallel to planes 52, values of the modulated index of refraction are substantially the same. The index of refraction planes form an optical, photorefractive grating that interacts with and diffracts reference and signal beams 32 and 42 that have interfered to generate the grating.

A portion of the energy in reference beam 32 is diffracted into a beam that combines with and propagates along with signal beam 42 and a portion of signal beam 42 is diffracted into a beam that combines with and propagates along with reference beam 32. The diffracted beams that “partner” with and travel along with reference and signal beams 32 and 42 are indicated by dashed block arrows 34 and 44 respectively. One of diffracted beams 34 and 44 interferes constructively with its partner beam and the other interferes destructively with its partner beam to effect an energy transfer between reference and signal beams 32 and 42. The magnitude of the energy exchange between reference and signal beams 32 and 42, and which of the beams gains energy and which loses energy, is a function of a coupling constant of photorefractive body 20 and a phase between the interference pattern and the modulation pattern of the index of refraction (i.e. by how much maxima in the modulation pattern are displaced from maxima in the interference pattern). If the relative phase between reference beam 32 and signal beam 42 changes, the amount of energy transmitted between the beams changes. Hereinafter, the combined beam comprising reference beam 32 and its partner, diffracted beam 34, upon exit from photorefractive body 20 is referred to as “exit reference beam 36”. Similarly the combined beam comprising signal beam 42 and its diffracted partner 44 is referred to as “signal exit beam 46”.

Conventionally, intensity of one of exit reference beam 36 and exit signal beam 46 is monitored to monitor change in the relative phase between reference beam 32 and signal beam 42. Changes in the relative phase are used to determine a change in distance to a test surface being monitored by the photorefractive interferometer that comprises photorefractive body 20 and reference and signal beams 32 and 42.

As shown in FIG. 1A, the conventional spatial configuration of reference and signal beams 32 and 42 in photorefractive body 20 and the interference pattern 50 they generate leave a relatively large portion 60 of the volume of photorefractive body 20 unexposed to the interference pattern. The interference pattern thus exhibits relatively large spatial inhomogeneity in the photorefractive body. For clarity of presentation, FIG. 1B schematically shows unexposed region 60 of photorefractive body 20 as a clear area without any wavefront markings 30 of reference beam 32. In addition to a conventional spatial configuration leaving relatively large portions of photorefractive body 20 unexposed to the interference pattern, intensity of light in the respective cross sections of the beams 32 and 42 generally exhibits substantial inhomogeneity. The inhomogeneity generates spatial inhomogeneity in interference pattern 50 resulting in some portions of the interference pattern exhibiting relatively high average field intensity while others exhibit relatively low average field intensity. Assuming for example that beam intensity in a cross section of beams 32 and 42 falls off rapidly with distance from the center of the beam, field intensity of interference pattern 50 is relatively weak along “edges” of the beams. Regions of interference pattern 50 that are relatively weak are indicated in FIGS. 1A and 1B by portions of lines 52 that are dashed. Average field intensity refers to field intensity averaged over several periods of the interference pattern.

The inventors have noted that regions of photorefractive body 20 for which intensity of interference pattern 50 is relatively strong have relatively increased conductivity as a result of a photoconductive effect generated by the interference pattern. On the other hand, regions of photorefractive body 20, such as region 60, that are not exposed to interference pattern 50 or regions for which the interference pattern is relatively weak have relatively low conductivity. In addition, not only does interference pattern 50 exhibit spatial inhomogeneity, but unexposed region 60 is not symmetric and increases in volume in the direction of propagation of reference beam 32.

As a result, the applied electric field generated by power supply 26 is relatively stronger in unexposed region 60 than in the region of interference pattern 50 and within the interference pattern is relatively stronger in those regions where the interference pattern is relatively weak. The applied electric field is therefore relatively weak in those regions of photorefractive body 20 where a relatively strong applied field is advantageous for enhancing the photorefractive grating, i.e. regions in which intensity of interference pattern 50 is relatively strong, and relatively strong in those regions of the photorefractive body where it is not effective, i.e. where the interference pattern is nonexistent or weak. (It is noted that attempting to compensate for the reduce applied field in regions where it is needed, by increasing the magnitude of voltage applied by power supply 26 to photorefractive body 20 can result in electric breakdown that damages the photorefractive body.) In addition, the asymmetric shapes of the unexposed region and the spatial inhomogeneity in the interference pattern distort the electric field so that the field lines are generally curved and not parallel to face 22 of the photorefractive body. The relatively reduced intensity of the applied electric field in regions of photorefractive body 20 where intensity of interference pattern 50 is relatively strong and spatial distortions in the applied field reduce the effectiveness of the voltage applied by power supply 26 in enhancing the photorefractive grating and the effectiveness of the grating in coupling the reference and signal beams. A change in phase between the signal and reference beams results in changes in the intensities of the reference and signal beams that are diminished relative to changes for the same phase change that would generally be observed were the applied field not distorted and relatively weak in those regions of photorefractive body 20 where interference pattern 50 is relatively strong.

It is noted that orienting reference and signal beams 32 and 42 symmetrically in photorefractive body 20 does not substantially reduce a volume of the photorefractive body unexposed to an interference pattern generated by the beams. FIG. 1C schematically shows reference and signal beams 32 and 42 oriented so that they enter photorefractive body 20 at a symetrical angle relative to the normal to face 22 while preserving the angle θ between them that is shown in FIGS. 1A and 1B. The two beams generate an interference pattern 70 in the photorefractive body. Clear regions 72 in photorefractive body 20 in the figure indicate regions of the photorefractive body for which interference pattern 70 is not present.

The inventors have determined that interacting reference and signal beams having relatively uniform intensity distribution over their respective cross sections and a symmetric configuration in photorefractive body 20 may be configured, in accordance with an embodiment of the invention, to provide improved sensitivity for a photorefractive interferometer comprising photorefractive body 20. The relatively uniform intensity distributions of the beams and their symmetric configuration tends to provide an interference pattern generated in the photorefractive body by the beams having improved spatial homogeneity and substantially reduce regions of the photorefractive body that are unexposed to the interference pattern. Without being bound by a particular theory, or the simplified model of photorefractivity presented above, the inventors believe that the spatial homogeneity and symmetric configuration tends to promote conductivity in photorefractive body 20 that is spatially more homogeneous as a function of position in the photorefractive body than prior art beam configurations. The enhanced spatial homogeneity of the conductivity results in an applied field generated in photorefractive body 20 by power supply 26 that is more homogenous than prior art applied fields and as a result, a photorefractive grating that is more effective in coupling reference and signal beams and effecting energy transfer between the beams.

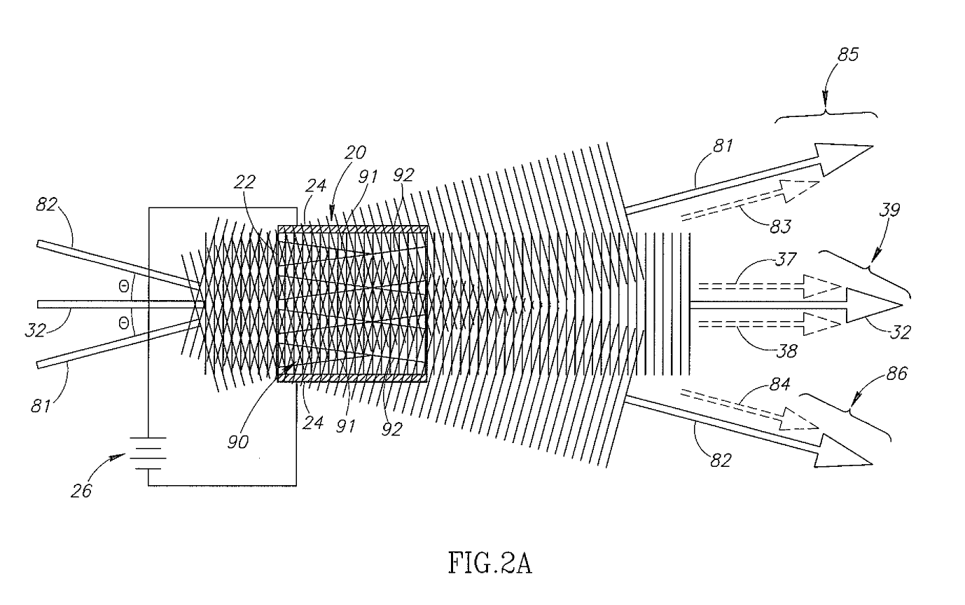

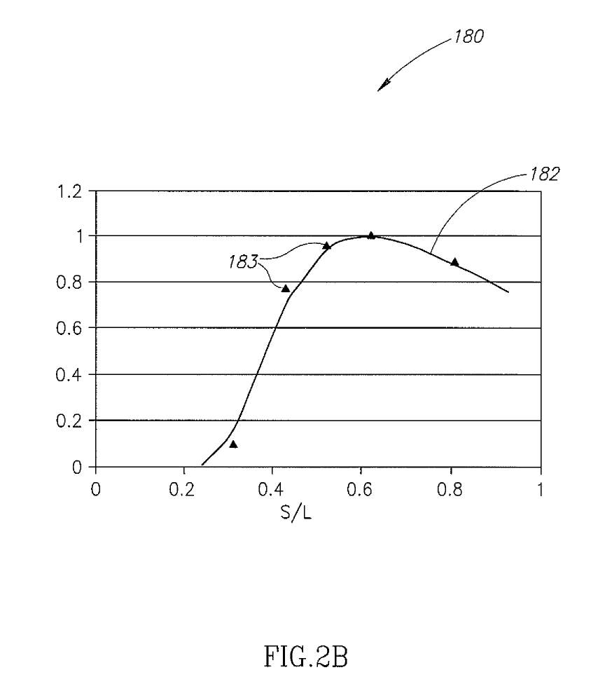

FIG. 2A schematically shows a symmetric configuration of reference and signal beams that interact in photorefractive body 20, in accordance with an embodiment of the invention.

By way of example, the configuration comprises reference beam 32 that enters photorefractive body 20 normal to face 22 and two signal beams 81 and 82 that enter the photorefractive body from opposite sides of the reference beam but at same angles θ to the normal. Signal beams 81 and 82 are optionally identical coherent beams that are in phase. Each signal beam 81 and 82 interferes with reference beam 32 and generates an electromagnetic field interference pattern 90 that produces a photorefractive grating in photorefractive body 20. Maximum phase planes in interference pattern 90 generated by signal beams 81 and 82 with reference beam 32 are indicated by lines 91 and 92 respectively.

Diffraction of reference beam 32 by the photorefractive gratings generated by interaction of the reference beam with signal beams 81 and 82 generates diffracted beams 83 and 84 that propagate and combine with signal beams 81 and 82 respectively to form exit signal beams 85 and 86. As a result of the symmetric configuration of signal beams 81 and 82 relative to reference beam 32, exit signal beams 85 and 86 are substantially identical mirror images of each other. Diffraction of signal beams 81 and 82 generate diffractive beams 37 and 38 respectively that propagate and combine with reference beam 32 to form an exit reference beam 39. Since signal beams 81 and 82 are coherent and optionally in phase, an amount and direction of energy transfer between each of the signal beams and the reference beam is the same for both signal beams. Both signal beams either transfer a same net amount of energy to the reference beam or receive a same net amount of energy from the reference beam.

In accordance with an embodiment of the invention, intensity of exit reference beam 39 is monitored to monitor change in the relative phase between reference beam 32 and signal beams 81 and 82. Changes in the relative phase are used to determine changes in distance to a test surface being monitored by a photorefractive interferometer in accordance with an embodiment of the invention that comprises photorefractive body 20 and reference and signal beams 32, 81 and 82. It is noted that whereas in the embodiment mentioned above, intensity of exit reference beam 39 is used to monitor changes in the test surface, changes in either exit signal beam 85 or 86 can be used to monitor the test surface.

From FIG. 2A it is seen that the symmetric configuration of a reference beam and two mirror image signal beams, in accordance with an embodiment of the invention, generate an interference pattern, interference pattern 90, that is distributed more homogeneously in photorefractive body 20 than prior art interference patterns. Interference pattern in 90 is established in substantially all of the volume of photorefractive body 20 and does not leave regions in the photorefractive body that are not exposed to the interference pattern. As noted above, without being bound by any particular theory, the inventors believe that the more homogeneous coverage of the volume of photorefractive body 20 by interference pattern 90 provides for a more uniform conductivity as a function of position in photorefractive body 20 than prior art interference patterns. As a result, for a given voltage, applied to photorefractive body 20 by power supply 26 an applied field is generated in the photorefractive body that is more uniform than in prior art and for a given voltage is relatively stronger in the region of the photorefractive body where it is advantageous for enhancing a photorefractive grating, in the region of an interference pattern generated by reference and signal beams.

It is noted that a laser beam, such as a reference beam or signal beam used in a photorefractive interferometer, generally does not have uniform light intensity inside the envelope of the beam. Intensity inside the envelope generally has a Gaussian profile in a cross section of the beam and intensity falls off with distance from the center of the cross section.

The fall off in intensity with distance from the center for reference and signal beams in a photorefractive interferometer contributes to distortion of an interference field generated by the beams in the interferometer's photorefractive body. An effect of non-uniform light intensity within the respective envelopes of reference and signal beams 32, 81 and 82 shown in FIG. 2A was ignored in the above discussion and it was silently assumed that light intensity in respective cross sections within the beams was substantially uniform.

Were only central parts of “Gaussian beams”, (for which changes in beam intensities are relatively moderate) used to establish an electromagnetic interference field in a photorefractive body, the field would be relatively homogeneous and contribute to moderating distortions in an applied electric field. However, by limiting the beams to only their respective central regions, optical energy carrying or potentially carrying information responsive to changes in a test surface is wasted. There is a tradeoff between limiting reference and signal beams to their central parts and losing information carrying optical energy. On the one hand limiting the beams to their central regions would appear to improve efficiency of a photorefractive interferometer by contributing to a more uniform electromagnetic interference field. On the other hand, limiting the beams to their central regions would appear to discard information bearing optical energy that would decrease the interferometer efficiency.

The inventors have determined for a photorefractive interferometer dependence of photorefractive efficiency of the interferometer as a function of uniformity of an interference pattern generated by reference and signal beams in the interferometer and thereby of the uniformity of intensity in the reference and signal beams. Assume that a photorefractive body, such as body 20 has a form of a rectangular parallelepiped having a square entrance face 22 of length L on a side. The inventors have determined that relative photorefractive efficiency “EF” of the interferometer for a given applied voltage V between electrodes 24 and a same given change in phase between the beams may be estimated by:

$$EF = α \frac{{V}^{2}}{( {\int }_{0}^{L} I ( x ) \cdot d x ) \cdot ( {\int }_{0}^{L} \frac{d x}{I ( x )} )} .$$

In the above expression, α is a constant of proportionality, x is a dimension perpendicular to electrodes 24 in FIG. 2A, i.e. in a direction substantially parallel to an electric field generated by applied voltage V, I(x) is intensity of the electromagnetic interference field generated by the reference and signal beams at coordinate x in a cross section of photorefractive body 20 parallel to entrance face 22 and perpendicular to the direction of polarization of reference and signal beams 32, 81 and 82.

The expression for EF has a maximum for reference and signal beams having beam intensities that are substantially uniform over the respective cross sections of the beams, i.e. for beams having flat beam intensity profiles for which, substantially, I(x)=C where C is a constant. Assuming that reference and signal beams that interact in the photorefractive body have Gaussian intensity profiles characterized by a same radius “s” (a distance from the center of the beam at which beam intensity falls by a factor of 1/e²), the inventors have found that EF is substantially a function of s/L. For convenience, for Gaussian intensity profiles, E is written as EF_{g}(s,L) and

$${EF}_{g} ( s , L ) = \frac{α {V}^{2}}{( {\int }_{0}^{L} I ( s , x ) \cdot d x ) \cdot ( {\int }_{0}^{L} \frac{d x}{I ( s , x )} )} .$$

FIG. 2B shows a graph 180 in which theoretical dependence of EF_{g}(s,L) on s/L for α=V=1 is indicated by a curve 182. Triangular icons 183 indicate values for EF_{g}(s,L) acquired in experiments performed by the inventors. For relatively small values of s/L, EF_{g}(s,L) is relatively small because, whereas substantially all the optical energy in the reference and signal beams interact in the photorefractive body, the interaction volume of the beams in the photorefractive body is a relatively small portion of the photorefractive body volume. The interaction volume has a relatively high electrical conductivity compared to the portion of the photorefractive body outside the interaction volume. The applied electric field generated by V is therefore substantially reduced inside the interaction volume and is relatively ineffective in enhancing the photorefractive coupling of the beams. As the ratio s/L increases, the interaction volume increases and becomes a greater portion of the total photorefractive body volume and the intensity of the applied electric field generated by V in the interaction volume increases. The applied field becomes more effective in enhancing the photorefractive coupling of the beams and EF_{g}(s,L) increases. For a value of s/L in a range centered about 0.6, EF_{g}(s,L) reaches a maximum and thereafter decreases as s/L increases. The decrease is due to an increasing loss of optical energy in the beams that participate in transfer of energy between the beams. As s/L increases beyond about 0.6, greater portions of a region in which the beams overlap lie outside the volume of photorefractive body 20, a smaller portion of the optical energy in the beams participates in photorefractive coupling between the beams and photorefractive efficiency EF_{g}(s,L) decreases.

The above discussion indicates that in accordance with an embodiment of the invention it can be advantageous to configure a reference beam and a signal beam responsive to the expression for EF_{g}(s,L) given above. For example, optionally, reference and signal beams 32, 81 and 82 are configured responsive to the expression for EF_{g}(s,L). It is noted that whereas graph 180 and the discussion of FIG. 2A refer to photorefractive efficiency for beams having a Gaussian intensity profile, the expression for EF applies for beams having substantially any intensity profile.

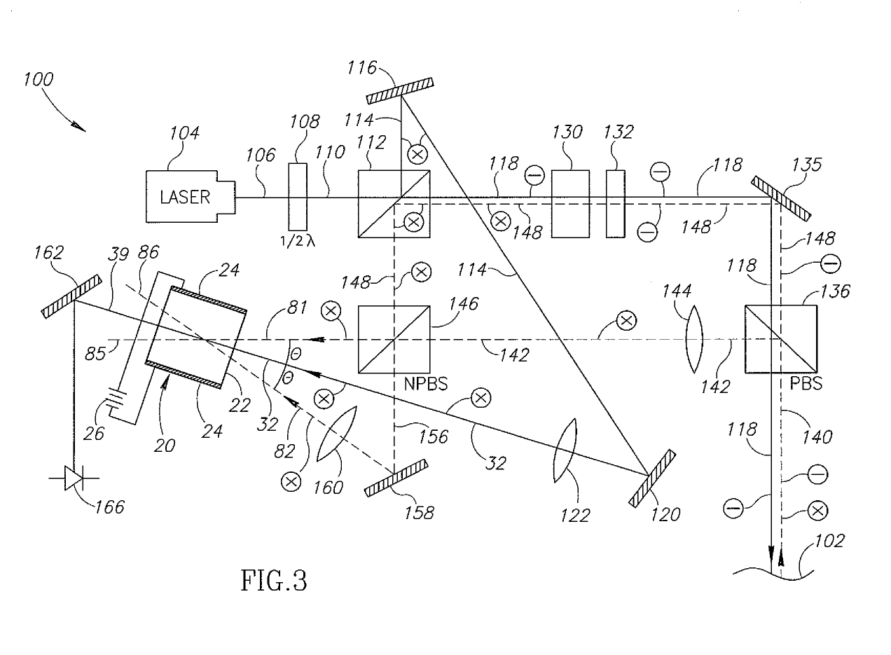

FIG. 3 schematically shows a photorefractive interferometer 100 comprising photorefractive body 20 connected to power supply 26 and a symmetric configuration of reference and signal beams 32, 81 and 82 shown in FIG. 2A, in accordance with an embodiment for the invention. Photorefractive interferometer 100 is schematically shown monitoring position of a test surface 102.

Interferometer 100 comprises an optionally CW laser 104 that produces a polarized beam of light 106 for providing reference beam 32 and signal beams 81 and 82 for the interferometer. For convenience of presentation, a given state of polarization of light is described by its components perpendicular and parallel to the plane of FIG. 3. The components are referred to as perpendicular and parallel components and are respectively represented by a circle with a cross inside and a circle with a horizontal line.

Polarized beam 106 is directed to a half wave plate 108, which is selectively oriented with respect to the polarization direction of beam 106 to provide a beam 110 having a polarization state characterized by a desired ratio between parallel and perpendicular polarization components. From half wave plate 108 light in beam 110 is incident on a polarization beam splitter (PBS) 112 which reflects perpendicularly polarized light in a beam 114 to a minor 116 and transmits parallel polarized light in a beam 118. (Polarization of beams 114 and 118 are indicated by the polarization icons associated with the beams.) Light in beam 114 is reflected by minor 116 to a mirror 120, which in turn reflects the light to a lens or optical system represented by a lens 122 to form reference beam 32. Lens 122 optionally configures reference beam 32 to have a relatively uniform intensity profile in photorefractive body 20. Optionally lens 122 configures reference beam 32 responsive to the expression for E, such as that given above to enhance photorefractive efficiency of interferometer 100 and optionally directs the beam perpendicular to face 22 of photorefractive body 20. For reference beam 32 having a Gaussian cross section, lens 122 optionally configures the reference beam responsive to an expression for EF_{g}(s,L).

Parallel polarized light that is transmitted by polarization beam splitter 112 as beam 118 is optionally incident on a Faraday rotator 130 that rotates the polarization of the light clockwise by 45° and then proceeds to a half wave plate 132 that rotates the polarization of the light counterclockwise by 45°. After passing through the Faraday rotator and the half wave plate, the polarization state of the light in beam 118 is unchanged, i.e. it remains parallel polarized (as indicated by the polarization icon associated with the beam). Light in beam 118 is reflected by a mirror 135 towards a polarization beam splitter 136 which transmits all the light in the beam. The transmitted light is directed, optionally via an optic fiber (not shown) to reflect off test surface 102. The reflected light is represented as being comprised in a “return light beam”, which is indicated by a dashed line 140 and light in the return beam is optionally transmitted back to polarizing beam splitter 136, optionally by an optic fiber (not shown).

Whereas light in beam 118 that is transmitted to reflect off test surface 102 was totally parallel polarized, after reflection from test surface 102 and transmission back and forth through an optic fiber, light in beam 140 is in general to some extent depolarized and contains both perpendicular polarized light and parallel polarized light. To indicate that light in return beam 140 comprises both parallel and perpendicular polarized light, return beam 140 is associated with the icons for both parallel and perpendicular polarized light.

Perpendicular polarized light in return beam 140 is reflected by polarizing beam splitter 136 as a beam 142 to a lens or optical system 144 that images the light on a non-polarizing beam splitter (NPBS) 146. Parallel polarized light in return beam 140 is transmitted to mirror 135 as a beam 148. Light in beam 148 is reflected by mirror 135 to pass through half wave plate 132 and Faraday rotator 130 and continue on to polarizing beam splitter 112. Whereas for light passing from polarizing beam splitter 112 to mirror 135, the rotations of Faraday rotator 130 and half wave plate 132 cancel to leave the polarization state of the light unchanged, in passing in the opposite direction the rotations provided by the half wave plate and the Faraday rotator add. As a result, after passing through half wave plate 132 and Faraday rotator 130, light in beam 148 which was parallel polarized when it left mirror 135 is rotated so that after it has passed through Faraday rotator 130 it is perpendicular polarized. The polarization states of light in beam 148 before and after passing through half wave plate 132 and Faraday rotator 130 are indicated by the polarization icons associated with the beam. Since the light in beam 148 is perpendicular polarized upon incidence on polarizing beam splitter 112 the beam splitter reflects all the light in beam 148 so that it is incident on non-polarizing beam splitter 146. All the light reaching non-polarizing beam splitter 146 in beams 148 and 142 is perpendicular polarized.

Beam splitter 146 optionally transmits substantially half of the light in each beam 142 and 148 into a first signal beam 81 that is transmitted to be incident on photorefractive body 20 at a non-zero angle θ relative to the normal to surface 22 and the direction of propagation of reference beam 32. Beam splitter 146 transmits half of the light in each beam 142 and 148 into a beam 156 that is directed to a mirror 158 which reflects the light it receives towards photorefractive body 20 as second signal beam 82 which is imaged by a lens or optical system 160 onto the photorefractive body. Second signal beam 82 is also incident on face 22 of photorefractive body 20 at angle θ. It is noted that configuration of interferometer 100 provides that light in all beams 32, 81 and 82 reaching photorefractive body 20 have a same, optionally perpendicular, state of polarization. In accordance with an embodiment of the invention, lenses 144 and 160 image light in beams 142 and 82 to have a relatively uniform intensity profile in photorefractive body 20. Optionally lenses 144 and 160 configure the beams responsive to the expression for E, or for the case of Gaussian beam profiles, responsive to EF_{g}(s,L) to enhance photorefractive efficiency of interferometer 100.

In photorefractive body 20 reference and signal beams 32, 81 and 82 interfere, generate photorefractive gratings and transmit energy between them as discussed with respect to FIG. 2A to form exit reference beam 39 and exit signal beams 85 and 86. Optionally, exit reference beam 32 is reflected by a mirror 162 to a photosensitive sensor, optionally a photodiode 166, which generates signals responsive to the intensity of exit reference beam 39. Changes in intensity registered by photodiode 166 are processed to determine changes in the position of test surface 102.

The inventors have determined that an interferometer, in accordance with an embodiment of the invention, similar to interferometer 100, may be operated to provide sensitivity to changes in distance to test surface 102 that is improved relative to sensitivity provided by prior art interferometers.

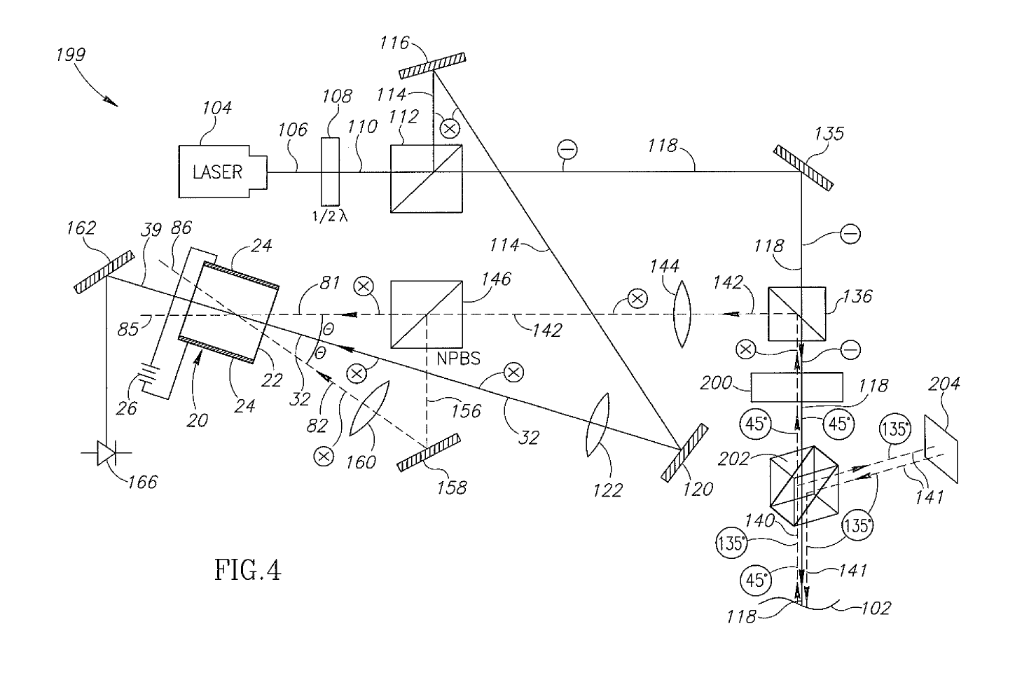

It is noted that methods and apparatus other than that shown in FIG. 3 for compensating for polarization instability introduced into beam 140 may be used in an interferometer in accordance with an embodiment of the invention. For example, the function of Faraday rotator 130 and half wave plate 132 may be replaced using a configuration of reflectors and beam splitters such as that shown in PCT Publication WO 2004/077100. FIG. 4 schematically shows another interferometer 199 similar to interferometer 100 but comprising apparatus different from that of interferometer 100 for compensating for polarization instability.

Interferometer 199 comprises many of the same components as interferometer 100 but does not use Faraday rotator 130 comprised in interferometer 100 to compensate for polarization instability. Instead, beam 118 that exits beam splitter 112 is optionally reflected directly to beam splitter 136 by mirror 135 and passes through the beam splitter to a Faraday rotator 200 that rotates the polarization of the beam from parallel to 45°. Beam 118 then proceeds to a polarizing beam splitter 202. A state of polarization, which is neither parallel nor perpendicular, of light in beam 118 and in other beams shown in FIG. 4, is indicated by a polarization angle inside a circle associated with the beam.

Beam splitter 202 is schematically shown in a perspective view because it is rotated by 45° out of a plane, in FIG. 4 the plane of the figure, defined by light beams 114 and 118 upon their exit from beam splitter 112. The beam splitter is rotated by 45° so that it transmits light beam 118 whose polarization is rotated by Faraday rotator 200 from parallel to 45°. “Rotated” beam 118 is then directed, optionally via an optic fiber (not shown) to reflect off test surface 102 as reflected beam 140 which is optionally transmitted back to beam splitter 202 by the fiber.

Whereas light in beam 118 after passage through Faraday rotator 200 is completely polarized at 45° to the plane of interferometer 199, after transmission through an optic fiber and reflection from test surface 102 in light beam 140, the light has a component polarized at 135° (i.e. 90° to the 45° polarization of beam 118). The light in beam 140 that retains the 45° polarization passes through beam splitter 200 and continues to Faraday rotator 200, which rotates the light by another 45° so that the light is perpendicularly polarized. The perpendicularly polarized light is reflected by beam splitter 136 as beam 142 to contribute to signal beams 81 and 82.

The light in beam 140 that is polarized at 135° is not transmitted on to Faraday rotator 200 but is reflected by beam splitter 202 to a mirror 204 as a beam 141. Mirror 204 reflects the light in beam 141 back to beam splitter 202, which because the light is polarized at 135° reflects the light to propagate back along the fiber to reflect off test surface 102 once again. The reflected light then returns back to beam splitter 202, but this time because of its propagation along the fiber and reflection by surface 102, the light is no longer purely 135° polarized but is admixed with 45° polarized light. The 45° polarized light is transmitted by beam splitter 20, rotated by Faraday rotator 200 and reflected by beam splitter 136 to contribute to beam 142 and signal beams 81 and 82. The component of beam 141 that remains polarized at 135° is again reflected by beam splitter 202 and mirror 204 to again reflect off test surface 102 and be admixed with 45° polarized light, which propagates on to Faraday rotator 200 and beam splitter 136 to contribute to signal beams 81 and 82. Light in beam 141 that remains polarized at 135° is repeatedly cycled back and forth between test surface 102 and mirror 204 until it is substantially all converted to light polarized at 45° and contributes to signal beams 81 and 82. The configuration of Faraday rotator 200, beam splitter 202 and mirror 204, in accordance with an embodiment of the invention, converts substantially all the light in beam 118 to perpendicularly polarized light that becomes part of signal beams 81 and 82.

It is noted that in many applications the round trip path length from mirror 204 to test surface 102 and the corresponding round trip “cycle time” are relatively short. For example if the fiber along which light is transmitted back and forth between beam splitter 202 and test surface 102 is on the order of half a meter, the round trip time of the cycle is on the order of about ten nanoseconds. In general, the energy in beam 141 is exhausted after a relatively small number of cycles. As a result, all the light in light beam 118 is accumulated to provide signal beams 81 and 82 in a relatively short period of time and the repeated cycling between mirror 204 and test surface 102 does not contribute substantially to dispersion of the signal beams.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the invention utilize only some of the features or possible combinations of the features. Variations of the described embodiments and embodiments of the invention comprising different combinations of features noted in the described embodiments will occur to persons of the art. The scope of the invention is limited only by the following claims.

1. A method of coupling optical energy comprising:
generating a first beam of optical energy;
generating a second beam of optical energy coherent with the first beam;
polarizing optical energy from the first and second beams in a same direction; and
transmitting the polarized optical energy from the first and second beams into a photorefractive body, with optics set up to configure the profiles of the optical energy from the first and second beams, so that the optical energy from first and second beams interferes in the body to generate an interference pattern extant in substantially all the volume of the body.

2. A method according to claim 1 wherein transmitting optical energy from the second beam comprises splitting the beam into third and fourth beams and transmitting the third and fourth beams into the body.

3. A method according to claim 2 wherein transmitting the first, third and fourth beams comprises transmitting them in directions so that the third and fourth beams intersect at an angle that is substantially bisected by the first beam.

4. A method according to claim 1 and comprising configuring the beams so that intensity of the optical energy transmitted into the photorefractive body from each beam is relatively uniform over the beam's cross section.

5. A method according to claim 1 and comprising configuring the beams to maximize an expression of the form:
$$\frac{1}{( {\int }_{0}^{L} I ( x ) \cdot d x ) \cdot ( {\int }_{0}^{L} \frac{d x}{I ( x )} )}$$
where I(x) is intensity of the electromagnetic interference field and the integral is performed over a coordinate x along a direction perpendicular to the direction of polarization of the beams that lies in a cross section of the photorefractive body substantially parallel to a surface at which the beams enter the body and L is a dimension of the cross section of the body.

6. A method according to claim 1 wherein generating the beams comprises generating beams having Gaussian intensity profiles characterized by a same radius that characterizes rates at which intensities of the beams decrease with distance from the centers of their respective cross sections.

7. A method according to claim 6 and determining a cross section size of each beam responsive to the radius of the beam and a dimension of the photorefractive body.

8. A method according to claim 6 wherein determining the size of each beam comprises determining the size responsive to a ratio between the radius of the beam and a dimension of the photorefractive body.

9. A method according to claim 1 and comprising applying a potential difference to the photorefractive body to generate an applied electric field in the body.

10. An interferometer comprising:
a first beam of optical energy;
a second beam of optical energy coherent with the first beam;
a photorefractive body; and
optics that polarizes optical energy in the beams along a same direction, directs the polarized optical energy from the first and second beams into the photorefractive body, and is set up to configures the profiles of the optical energy from the beams so that the optical energy from the first and second beams interferes in the body to generate an interference pattern extant in substantially all the volume of the body.

11. An interferometer according to claim 10 wherein the optics splits the second beam into third and fourth beams.

12. An interferometer according to claim 11 wherein the optics that directs optical energy comprises optics that directs the first, third and fourth beams so that the third and fourth beams intersect at an angle that is substantially bisected by the first beam.

13. An interferometer according to claim 12 and comprising optics that configures the beams to maximize an expression of the form:
$$\frac{1}{( {\int }_{0}^{L} I ( x ) \cdot d x ) \cdot ( {\int }_{0}^{L} \frac{d x}{I ( x )} )}$$
where I(x) is intensity of the electromagnetic interference field generated by the first, third and fourth beams and the integral is performed over a coordinate x along a direction perpendicular to the direction of polarization of the beams that lies in a cross section of the photorefractive body substantially parallel to a surface at which the beams enter the body and L is a dimension of the cross section.

14. An interferometer according to claim 10 and comprising a laser that provides light for both the first and second beams.

15. An interferometer according to claim 14 comprising a first beam splitter that splits light from the laser into the first and second beams.

16. An interferometer according to claim 15 wherein the first beam splitter is a polarizing beam splitter that polarizes the light in the first and second beams in first and second directions respectively that are orthogonal to each other.

17. An interferometer according to claim 16 wherein the optics comprises a Faraday rotator and optics that directs at least some of the light in the second beam to pass at least twice through the Faraday rotator before it enters the photorefractive body.

18. An interferometer according to claim 17 wherein for each pass of the light through the Faraday rotator, the polarization direction of the light is rotated by 45°.

19. An interferometer according to claim 17 and comprising a non-polarizing beam splitter that receives light that passes through the Faraday rotator twice and splits the received light into the third and fourth beams.

20. An interferometer according to claim 19 wherein the interferometer splits equal portions of the received light into the third and fourth beams.

21. An interferometer according to claim 19 and comprising a second polarizing beam splitter that receives light that has passed through the Faraday rotator only once and transmits light polarized in the second direction and reflects light polarized in the first direction.

22. An interferometer according to claim 21 wherein the second polarizing beam splitter reflects light polarized in the second direction to the non-polarizing beam splitter, which splits the received light into the third and fourth beams.

23. An interferometer according to claim 18 wherein the optics that directs the light to pass at least twice through the Faraday rotator comprises a second polarizing beam splitter that receives light from the Faraday rotator that has passed though the rotator only once and has its polarization direction rotated into a third polarization direction at 45° to the second polarization direction.

24. An interferometer according to claim 23 wherein the second polarizing beam splitter transmits light polarized in the third direction and reflects light polarized in a fourth polarization direction that is perpendicular to the third polarization direction.

25. An interferometer according to claim 24 and comprising a mirror that reflects light polarized in the fourth direction that is reflected by the second beam splitter back to the second beam splitter.

26. An interferometer according to claim 10 and comprising a power supply that applies a potential difference to the photorefractive body to generate an applied electric field in the body.

27. (canceled)

28. A method according to claim 1, wherein generating the first and second beams each comprise generating the beam with a radius approximately or greater than 0.6 times a width of the photorefractive body perpendicular to the beam, the radius being defined as a distance at which the beam intensity falls to 1/e² of the intensity at the center of the beam, and transmitting the energy of the first and second beams into the photorefractive body comprises transmitting the centers of the beams substantially through the center of the photorefractive body.

29. A method according to claim 1, wherein generating the first and second beams each comprise generating the beam with substantially uniform intensity over the beam cross-section.

30. An interferometer according to claim 10, wherein the first and second beams each have a radius approximately or greater than 0.6 times a width of the photorefractive body perpendicular to the beam, the radius being defined as a distance at which the beam intensity falls to 1/e² of the intensity at the center of the beam, and the optics directs the first and second beams into the photorefractive body with the centers of the beams passing substantially through the center of the photorefractive body.

31. An interferometer according to claim 10, wherein the first and second beams each have substantially uniform intensity over the beam cross-section.

32. A method according to claim 1, wherein the optical energy from the first and second beams is transmitted into the photorefractive body through an entry face of the body, and for one or both of the first and the second beams, the intensity of the optical energy is substantially uniform across the body, in a cross-section of the body that is parallel to the entry face.

33. An interferometer according to claim 10, wherein the optical energy from the first and second beams is directed into the photorefractive body through an entry face of the body, and for one or both of the first and the second beams, the intensity of the optical energy is substantially uniform across the body, in a cross-section of the body that is parallel to the entry face.

34. A method according to claim 9, wherein the profiles of the optical energy of the first and second beams are configured, and the optical energy of the first and second beams is transmitted, so that, in at least a portion of the photorefractive body across which portion the potential difference is applied, the electric field is not inordinately concentrated in one region at the expense of other regions.
